(19) United States
(12) Patent Application Publication
(10) Pub. No.: US 2009/0185620 A1
(43) Pub. Date: Jul. 23, 2009

(54) VIDEO ENCODING APPARATUS AND METHOD FOR THE SAME

(75) Inventor: ATSUSHI MATSUMURA, Yokohama-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 12/233,627

(22) Filed: Sep. 19, 2008

(30) Foreign Application Priority Data
Jan. 17, 2008 (JP) 2008-008361

(51) Int. Cl. H04N 7/26

(52) U.S. Cl. 375/240.02; 375/E07.127

(57) ABSTRACT

A video encoding apparatus includes a calculator to calculate a bit rate every time interval of input encoded data from the number of encoded bits of each of a plurality of time intervals derived from the input encoded data by division in a decoding time direction, the input encoded data including variable bit rate encoded data encoded at a variable bit rate beforehand, a calculator to subtract the input bit rate from the first transmission bit rate to obtain a second transmission bit rate every time interval, and an encoder to encode video data according to the second transmission bit rate to output encoded data.

### CROSS-REFERENCE TO RELATED APPLICATIONS

This application is based upon and claims the benefit of priority from prior Japanese Patent Application No. 2008-008361, filed Jan. 17, 2008, the entire contents of which are incorporated herein by reference.

### BACKGROUND OF THE INVENTION

1. Field of the Invention

The present invention relates to a video encoding apparatus capable of setting efficiently the transmission bit rate of video data to be multiplexed and realizing quality variable bit rate control by investigating preliminarily a change of a bit rate of data encoded at a variable bit rate beforehand, and a method for the same.

2. Description of the Related Art

A stochastic multiplex control apparatus has been developed which encodes video data of plural channels at the same time at a give multiplexed transmission bit rate and optimizes distribution of bit rates between the channels to multiplex the video data (JP-A 2001-359094 (KOKAI), and JP-A 2002-58022 (KOKAI)).

The data to be multiplexed is not only video data, but also audio data. Particularly in recent years, a codec such as DolbyTrueHD and DTSHD that subject an audio to lossless variable length compression is adopted in the HD DVD which is a next-generation DVD standard, and the audio data is multiplexed with the video data and recorded on a HD DVD disk.

The conventional stochastic multiplex control is based on real-time processing, and can adjust the number of encoded bits between channels, but has a problem that it is not optimized in a time axis direction. When the video data is multiplexed with the audio data to be subjected to lossless variable length encoding, it is impossible to adjust the number of encoded bits of the audio data. Accordingly it is difficult to multiplex the video data with the lossless audio data adequately like the conventional stochastic multiplex control. The bit rate is variable in the lossless audio data. In this case, lossless audio bit rate occupies the transmission bit rate and the remaining transmission bit rate is assigned to the video data. Therefore, the part in which the bit rate of lossless audio is higher, in other words, the part in which the bit rate of video is low cannot be used effectively.

It is an object of the present invention to provide a video encoding apparatus for encoding a video by analyzing how the bit rate of encoded data fluctuates when the lossless audio is encoded, and setting in dynamic a transmission bit rate of the video data on the basis of the analytical information, and a method for the same.

### BRIEF SUMMARY OF THE INVENTION

An aspect of the present invention provides a video encoding apparatus comprising: a calculator to calculate a bit rate for every time interval of input encoded data from the number of encoded bits of each of a plurality of time intervals obtained by dividing the input encoded data in a decoding time direction, the input encoded data including variable bit rate encoded data encoded at a variable bit rate beforehand; a calculator to calculate a second transmission bit rate for every time interval by subtracting the input bit rate from the first transmission bit rate; and an encoder to encode video data according to the second transmission bit rate to output encoded data.

### BRIEF DESCRIPTION OF THE SEVERAL VIEWS OF THE DRAWING

FIG. 1 is a block diagram illustrating a video encoder based on a variable bit rate and input and output data thereof according to a first embodiment.

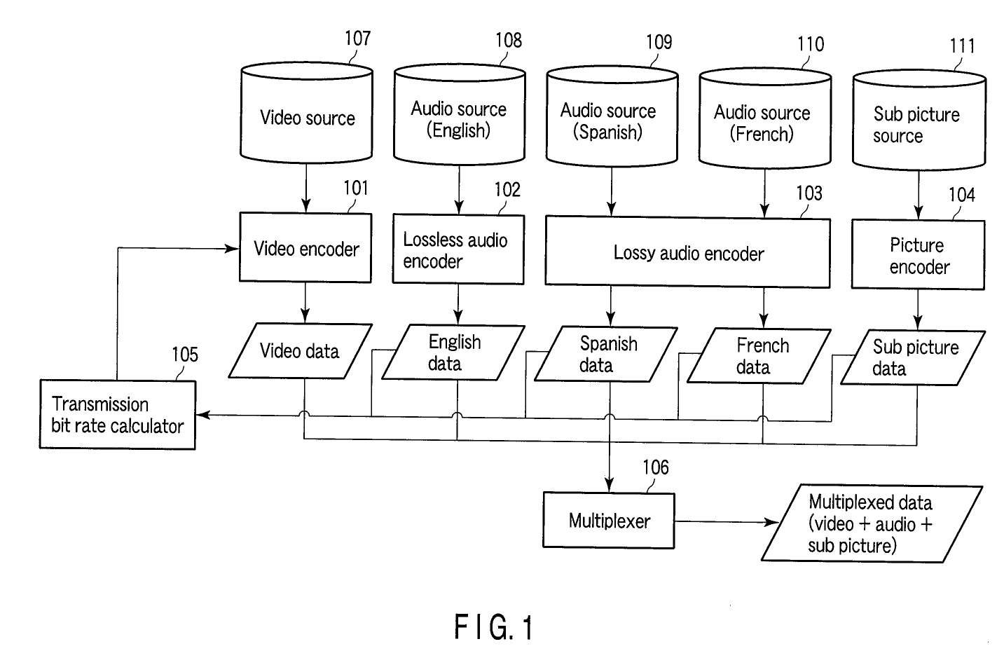

FIG. 2 is a flowchart illustrating an operation of the video encoder for generating data input thereto according to the first embodiment.

FIG. 3 is a diagram for explaining to calculate a bit rate in units of AU.

FIG. 4 is a diagram for explaining to calculate a bit rate in a given temporal interval.

FIG. 5 is a diagram for explaining to calculate a transmission bit rate of the video.

FIG. 6 is a flowchart illustrating an operation of modification of the first embodiment.

FIG. 7 is a block diagram illustrating a video encoder based on a variable bit rate and input and output data thereof according to a second embodiment.

FIG. 8 is a flowchart illustrating an operation of the video encoder for generating data input thereto according to the second embodiment.

FIG. 9 is a diagram illustrating assignment of multiplexed data and empty.

### DETAILED DESCRIPTION OF THE INVENTION

There will now be described embodiments of the present invention in conjunction with accompanying drawings.

### First Embodiment

The video encoding apparatus is comprised of a video encoder 101, a lossless audio encoder 102, a lossy audio encoder 103, a sub picture encoder 104 and a transmission bit rate calculator 105. The video encoder 101 is connected to the video source 107 and encodes input video data while performing variable bit rate control based on a transmission bit rate given by the transmission bit rate calculator 105 and outputs video data. The lossless audio encoder 102 is connected to an audio source (English) 108 and encodes the input audio (English) using lossless variable bit rate encoding to output English data. The lossy audio encoder 103 is connected to an audio source (Spanish) 109 and audio source (French) 110, and encode the input audio (Spanish, French) using lossy constant bit rate encoding to output Spanish data and French data. The sub picture encoder 104 is connected to a sub picture source 111, and encodes the input sub picture to output sub picture data.

The transmission bit rate calculator 105 measures the bit rate of data encoded beforehand (i.e., the lossless English audio data, lossy Spanish audio data, French audio data, sub picture data), and sets a target transmission bit rate to the video encoder 101. The data multiplexer 106 multiplexes the video data, the audio data and the sub picture data, and outputs multiplexed data (video+audio+sub picture). The system for this multiplexing may be MPEG2PS (Program Stream) or MPEG2TS (Transport Stream).

The data encoded beforehand in the present embodiment includes one lossless audio data, two lossy audio data and one sub picture data as described above, but the present invention is not limited to combination of them and the number of them.

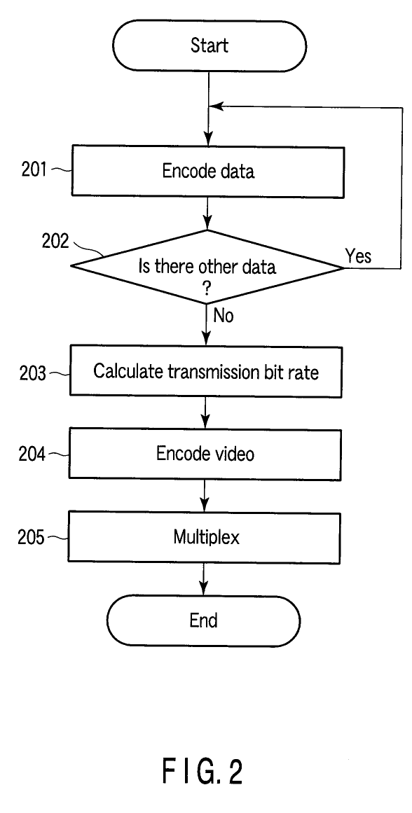

There will now be described an operation of a video encoding apparatus based on a variable bit rate according to the present embodiment with reference to FIG. 2. The lossless audio encoder 102 receives the input data (English) and encodes it (step 201). There are various lossless audio encoding methods such as DolbyTrueHD, DTSHDMasterAudio, and linear PCM. In the present embodiment, the DolbyTrueHD or DTSHD is assumed to be used for optimizing the transmission bit rate of the video data when there is data encoded at a variable bit rate.

It is confirmed before encoding the video data whether there is other data (step 202). In the present embodiment, since the remaining data includes two audios and one sub picture, it is continued to encode these data (step 201). In other words, the lossy audio encoder 103 receives the input data (Spanish and French) and encodes it. There are various lossy audio encoding methods such as AC-3, MP 3, but a method of encoding data at a constant bit rate is assumed to be adopted here, and a codec is not limited particularly. The sub picture encoder 104 receives the input data (closed caption data) and encodes it (step 201). If all data aside from video data have been processed, the process advances to the next process (step 203).

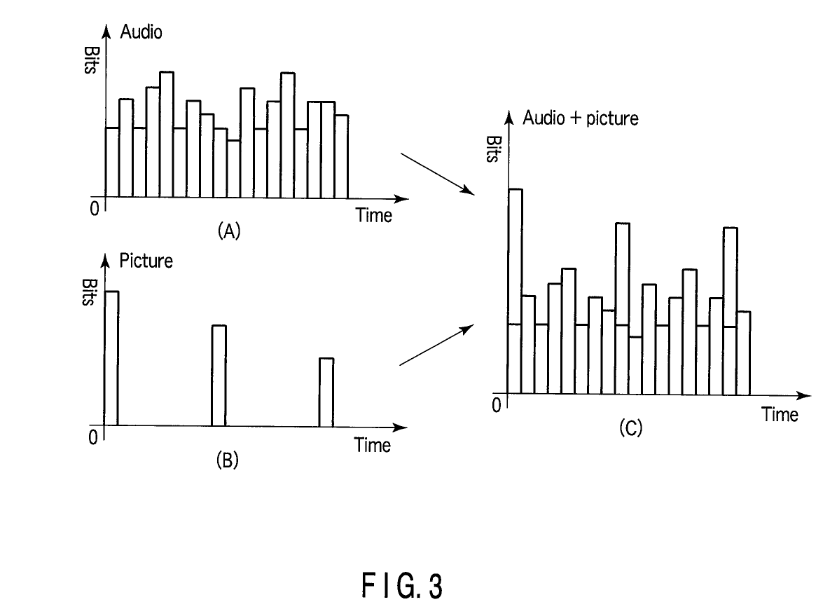

The transmission bit rate calculator 105 calculates a bit rate of combination of the encoded data (one lossless audio, two lossy audios, one sub picture). As for the bit rate of the audio, if the number of encoded bits in units of AU (access unit) is plotted in a time axis direction, the change of bit rate in minimum time interval is easily provided as shown in FIG. 3(A). Meanwhile, as for the sub picture, because display timing (or decoding timing) is discontinuous in a time axis, when the number of encoded bits is plotted simply in units of AU, the change of bit rate is discontinuous as shown in FIG. 3(B). When the bit rate is calculated by combining these bit rates simply, the bit rate of large unevenness is calculated as shown in FIG. 3(C).

The above calculation has no problem in terms of calculation of a bit rate in a small unit. However, when the video encoder 101 is assumed to carry out variable bit rate control based on the transmission bit rate finally calculated at this bit rate, the unit of the variation interval of the bit rate is too small. For example, if the encoding scheme of the video encoder 101 is H.264, the CPB (Coding Picture Buffer) is controlled according to the change of the transmission bit rate in a unit of the picture with SPS (Sequence Parameter Set). Usually, SPS is included in an I picture, and often exists at an interval of 0.5 sec so as to be effective for a random access and the like. Under such a condition, it is desirable to set the time interval for calculating the bit rate at an interval longer than 0.5 sec. Alternatively, it may be set at an interval longer than the length of GOP (group of picture) to be encoded. Also, it may be set at a value larger than a value obtained by dividing the size of the buffer of a system target decoder, which is needed to separate the data multiplexed at the transmission bit rate, at the transmission bit rate.

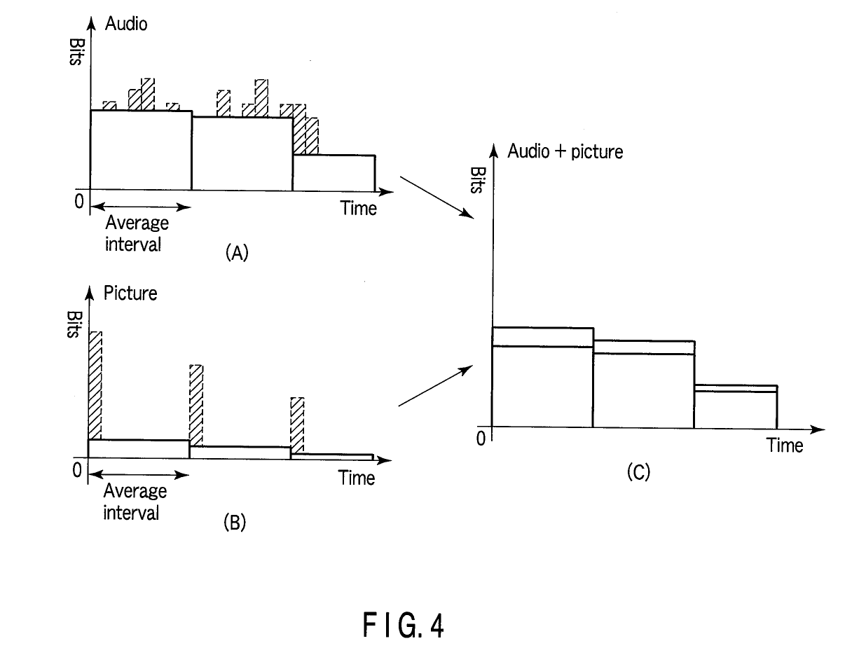

When the bit rate is calculated over specified time intervals (plural AUs), the smoothed bit rate is calculated as shown in FIG. 4. In addition, the number of encoded bits of AU may be calculated while parsing audio data and sub picture (detecting a start code by simple decoding). Also, it may be output as a log while the lossless audio encoder 102, lossy audio encoder 103 or sub picture encoder 104 encodes the number of encoded bits of each AU, and the transmission bit rate calculator 105 may receive it.

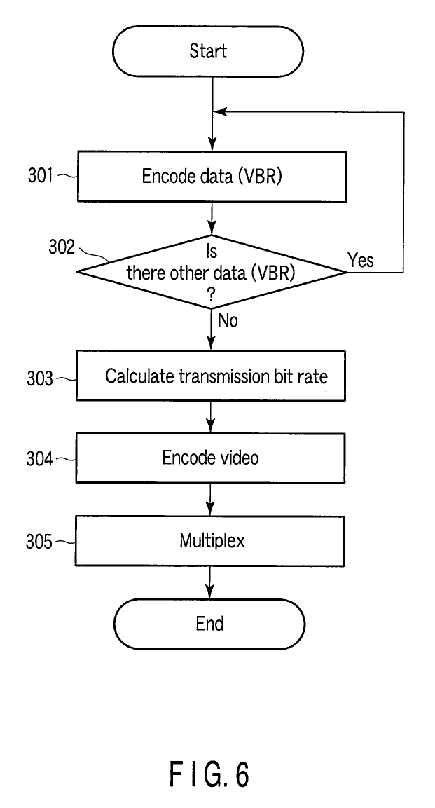

For example, Spanish and French of the audio data are due to be encoded at a constant bit rate. If this situation is known beforehand, a user needs not to wait that the lossy audio encoder 103 has actually encoded the audio data. The bit rate has only to be calculated from a value of the target constant bit rate, encoded lossless audio compressed data and sub picture compressed data. In this case, the processing flow is changed to FIG. 6 unlike FIG. 2. Because calculation of the bit rate is difficult until the encoding a lossless audio (variable bit rate) data is finished, that is, the bit rate control cannot be carried out due to lossless, it needs to encode the data beforehand.

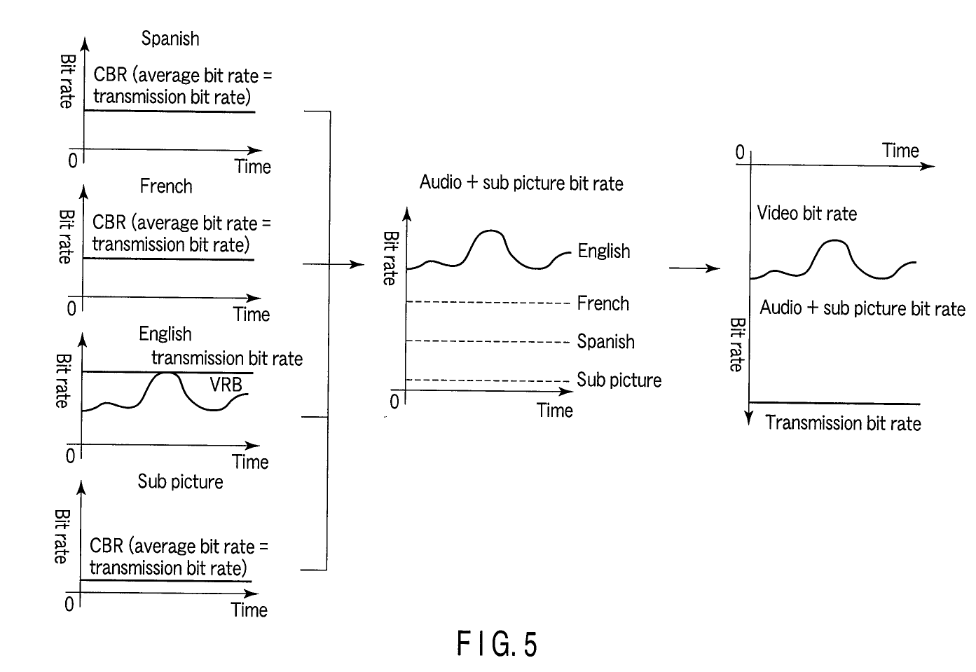

As above described, after the input bit rate every time interval of the input encoded data is calculated from the number of encoded bits of each of a plurality of time intervals derived from the input encoded data by division in a decoding time direction, the input encoded data including variable bit rate encoded data encoded at the variable bit rate beforehand, the decoding time direction corresponding to a decoding order of AU (pictures, slices) in the input encoded data, that is, after calculation of the bit rate of data encoded beforehand is competed, calculation of the transmission bit rate is performed (step 203). Concretely, the transmission bit rate of the video is calculated by subtracting variation of the bit rate from the target transmission bit rate (as the system) as shown in FIG. 5. In other words, the second transmission bit rate every time interval is calculated by subtracting the input bit rate from the first transmission bit rate.

The video encoder 101 receives the input data (video) from the video source 107, and encodes the input data while carrying out variable bit rate control according to the transmission bit rate calculated with the transmission bit rate calculator 105 (step 204). There are various variable bit rate control systems. However, in the present embodiment, a control method according to a value of the calculated transmission bit rate or target bit rate (that is, average bit rate) will be explained.

1. The Maximum of Transmission Bit Rate≦Target Bit Rate

The set transmission bit rate fluctuates at specified time intervals, but when the target bit rate at the time of controlling the variable bit rate is larger than the maximum of the transmission bit rate through the entire time interval, the number of encoded bits is assigned to satisfy transmission bit rate=target bit rate and the variable bit rate control is done. If the number of encoded bits is assigned by a larger value than the transmission bit rate, the buffer of the virtual decoder may underflow and thus the encoded data is against conformance standard. In addition, the control for assigning the number of encoded bits in this time needs not to be two-path variable bit rate control and comes to be a one-path variable bit rate control.

2. The Number of Encoded Bits Assigned at the Transmission Bit Rate≦the Number of Encoded Bits Assigned by the Target Bit Rate (Bit Rate×Time of Input Video Data=the Assigned Number of Bits)

When the change of the set transmission bit rate is intense, this condition may be satisfied. When this condition is satisfied, processing similar to the above method 1 is done. In other words, when the target bit rate at the time of controlling the variable bit rate is larger than the maximum of the transmission bit rate through the entire time interval, the number of encoded bits is assigned so as to satisfy transmission bit rate=target bit rate, and the variable bit rate control is done.

3. Method Other Than the Above Methods 1 and 2

When the methods 1 and 2 are inapplicable, the variable bit rate control is possible under the conditions that the target bit rate does not coincide with the transmission bit rate. For a simple method there is a method of confirming whether the buffer of the virtual decoder is broken at the transmission bit rate after the number of encoded bits is assigned to the whole input video data at the target bit rate uniformly. In other words, if the minimum of the transmission bit rate exceeds the target bit rate, the crash does not occur. However, if it is less than the target bit rate, the crash may occur. When this is realized by one-path process, the bit rate control is done so as to reduce the assigned number of bits at the time that the buffer of the virtual decoder is about to underflow in the process of encoding, namely, occupancy comes to be not more than a given threshold. The number of encoded bits deleted in the bit rate control is stored in a memory (not shown) so as to be used when the buffer of the virtual decoder is available.

After a risk of underflow of the buffer of the virtual decoder goes away, the number of encoded bits stored in the memory is used. The number of encoded bits stored may be distributed to the images to be encoded uniformly or may be assigned to a scene whose encoding is difficult, intentionally. In any case, the number of encoded bits stored have only to be used for an object having no risk of underflow of the virtual decoder buffer. Even if it is difficult to encode a scene, there is a case where the transmission rate is high, that is, the number of encoded bits of lossless audio data is few. This is due to a possibility that a temporal correlation between a complexity of encoding the video data and a complexity of encoding audio data is low.

The above processing is realized by one path but can be realized by two paths. If it is realized by two paths, it is possible to reduce the number of encoded bits to be assigned to a scene where the buffer of the virtual decoder may underflow and assign the number of encoded bits deleted in reducing the bits to other scenes. It is possible to realize the higher level of control than feedback processing like one path, that is, processing intended to process only an image on and after the present. However, if it is two-path processing, the number of encoded bits is not assigned to the whole input video data uniformly as described above, but assigned to the input video data according to the encoding complexity analyzed in the processing of the first path. In other words, the number of encoded bits is assigned to each image when the variable bit rate control is carried out at a given transmission bit rate. If the assignment of the number of encoded bits and the transition simulation of the buffer of the virtual decoder based on the transmission bit rate are carried out so that the number of encoded bits of a certain part posing a risk of underflow is distributed to another scene, more advanced variable bit rate control is enabled. It is necessary to analyze the lossless audio compressed data making it impossible to perform bit rate adjustment beforehand for such an effective variable bit rate control to be done. The input video data is compressed while the variable bit rate control is done based on such a control.

The data multiplexer 106 receives one video encoded data, one lossless audio encoded data, two lossy audio encoded data, and one sub picture encoded data and multiplexes them (step 205). There are various multiplexing methods such as Program Stream or Transport Stream, which is prescribed by a MPEG2 system. In any case, the multiplexing is done at the transmission bit rate not less than the transmission bit rate (as a system) which the transmission bit rate calculator 105 aims at. When the multiplexed data is output, the processing flow of the first embodiment is finished.

### Second Embodiment

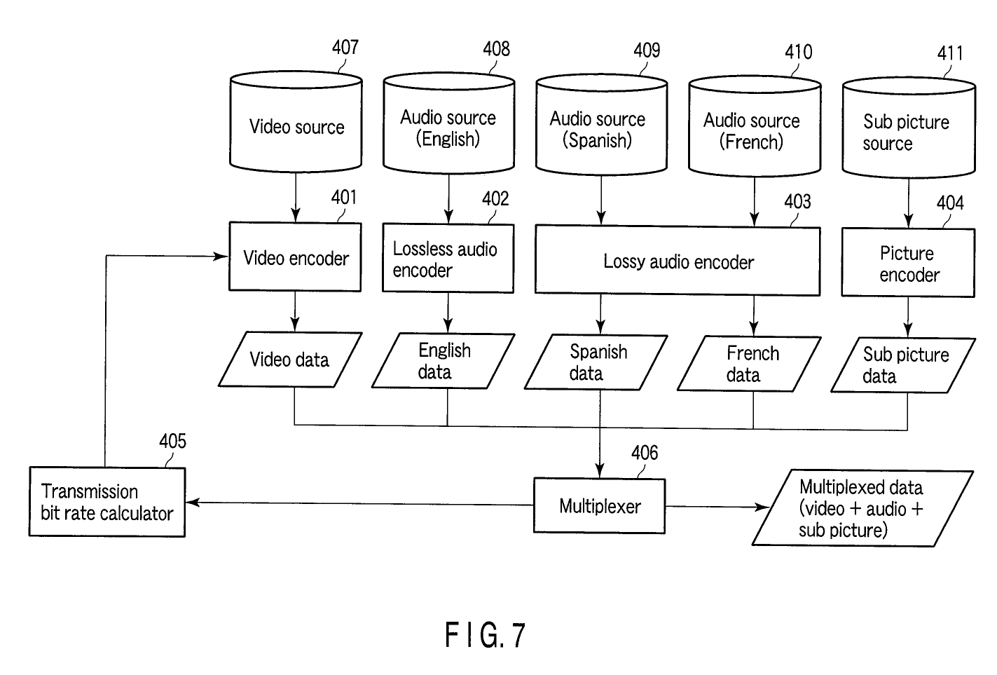

A video encoding apparatus of the second embodiment shown in FIG. 7 is comprised of a video encoder 401, a lossless audio encoder 402, a lossy audio encoder 403, a sub picture encoder 404 and a transmission bit rate calculator 405. The video encoder 401 encodes the video data input from the video source 407 while carrying out the variable bit control based on a transmission bit rate given with the transmission bit rate calculator 405. The lossless audio encoder 402 encodes the audio (English) data input from the audio source 408 using lossless variable bit rate encoding. The lossy audio encoder 403 encodes audio (Spanish, French) data input from the audio sources 409 and 410 using lossy constant bit rate encoding. The sub picture encoder 404 encodes sub picture data (closed caption data) input from the sub picture source 411.

The data multiplexer 406 multiplexes the data encoded beforehand (lossless English audio data, lossy Spanish audio data, lossy French audio data, sub picture data) or the video data encoded with the video encoder 401. The transmission bit rate calculator 405 calculates the bit rate of data which can be multiplexed further with the input multiplexed data and sets it to the video encoder 401 as a target bit rate. The data encoded beforehand in the present embodiment is one lossless audio data, two lossy audio data and one sub picture data as described before. However, the present invention is not limited to combination of them or the number of data.

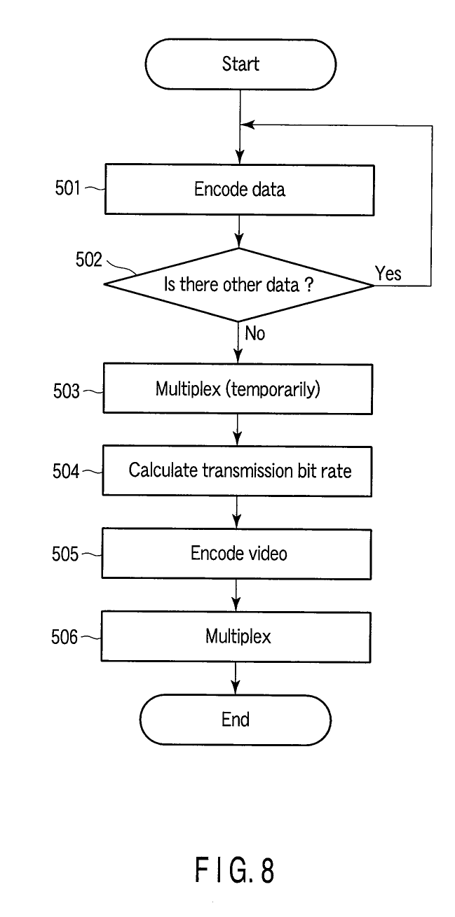

There will now be described an operation of the video encoder based on the variable bit rate according to the present embodiment with reference to FIG. 8. The video encoder 401, lossless audio encoder 402, lossy audio encoder 403 and sub picture encoder 404 receive input data of audio and sub picture from the video source 407, audio source 408, audio sources 409 and 410, and sub picture source 411. Steps 501 and 502 of encoding these input data are similar to steps 201 and 202 of the first embodiment.

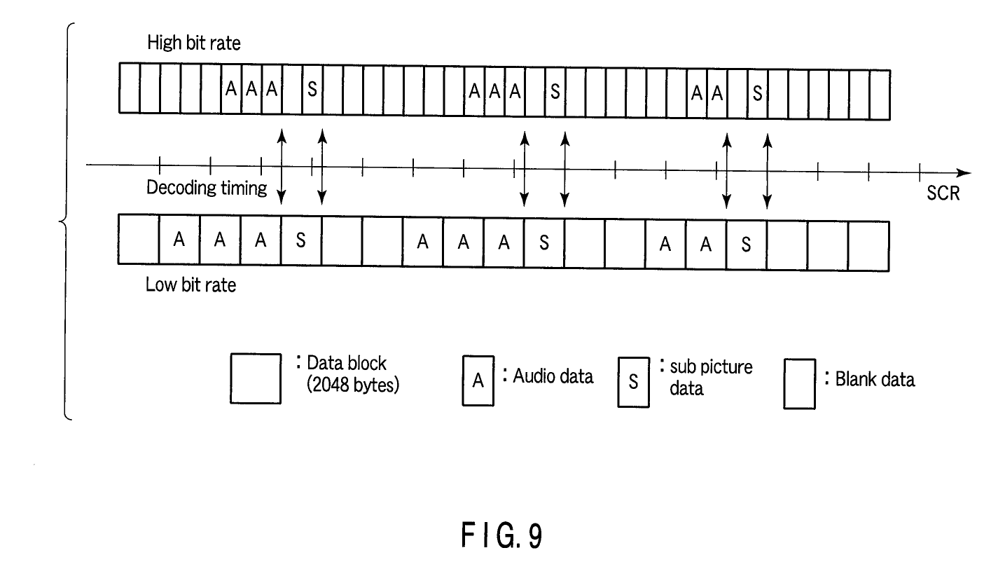

The data multiplexer 406 subjects the data having been encoded by step 502 to temporal multiplexing on the basis of a target transmission bit rate (as a system) (step 503). There are various methods for multiplexing data. However, in these multiplexing methods, the size of the separation virtual buffer for the audio data or sub picture data is smaller than that of the separation virtual buffer. Therefore, the audio data or sub picture data wherein the amount of delay can be absorbed in the buffer size are multiplexed for minimizing a delay time. In other words, the encoded data and the video data are multiplexed for the purpose of minimizing a delay time from the time when the data encoded beforehand at a variable bit rate is input to the decoder buffer to the time when it is decoded. The state is shown in FIG. 9.

In FIG. 9, the quadrature axis indicates SCR (system clock reference) representing a time of the system, the data interval when the transmission bit rate is high is shown on the upper side of this axis, and the data interval when the transmission bit rate is low is shown on the bottom side of the axis. The number of data blocks existing in the same SCR interval increases with increase of the bit rate. In FIG. 9, the block size of the data is set to 2 KB (2048 bytes), and the audio data and sub picture data are stored respective data blocks. In other words, in FIG. 9, A is the audio data, and S is the sub picture data. When these are multiplexed, the data blocks to which the data A and S are input are determined, and the data are input to these blocks sequentially. In this case, if the bit rate of the audio is low, audio/video data are output. In this time, the data is input to the data block in time for output of the audio/video data.

The video cannot absorb a delay since the buffer is large, and the audio cannot absorb a delay since the buffer is small. Accordingly, the system is configured so that the audio data is output immediately when it is input in the buffer. In other words, the audio data is saved in the region of the buffer as near to timing of decoding and the video is stored in the remaining region. So, since the buffer has an ample region, the video data is stored in the buffer and output afterward. If the bit rate is high, available data blocks increase. Accordingly, the bit rate can be calculated by whether there are how many available blocks per unit of time, and it can be estimated whether how many data can be transmitted.

The video data to be encoded from now is saved in the blank data. In addition, the present embodiment employs a method for multiplexing data for the purpose of minimizing the amount of decoding delay of the audio and sub picture by setting the data block size to 1 KB, but the present invention is not limited to this method. For example, the block size may be more than 2 KB. Alternatively, the audio and sub picture may be multiplexed so that the amount of decoding delay becomes maximum, and the transmission bit rate calculator 406 may calculates a transmission bit rate to be set to the video encoder 401 from the available data interval. Further, the multiplexing method may be changed in the middle of a sequence. For example, the amount of delay may be maximum in the first half, and minimum in the latter half.

The temporal multiplexed data in which the video data is not yet multiplexed is input to the transmission bit rate calculator 405, and the transmission bit rate capable of setting to the video encoder 401 is calculated from the blank data and SCR (step 504). The bit rate calculation can be done by counting the blank data in a given SCR interval, and the SCR interval in this time can have some time interval similarly to the interval described in the first embodiment.

Encoding processing on and after step 505 is omitted because it is similar to the processing on and after step 204 of the first embodiment.

The video encoding apparatus can be realized by using general-purpose computer equipment as a basic hardware. In other words, the video encoder, lossless audio encoder, lossy audio encoder, sub picture encoder, transmission bit rate calculator and data multiplexer can be realized by causing the processor built in the computer apparatus to execute the program. At this time, the video encoding apparatus may be realized by installing the program in a computer beforehand. Also, the program may be stored in a recording medium such as CD-ROM or distributed through a network and installed into the computer appropriately.

According to the present invention, it is possible to realize quality video encoding by performing effective variable bit rate control making best use of a give multiplexed transmission bit rate. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video encoding apparatus comprising:
a calculator to calculate a bit rate every time interval of input encoded data from the number of encoded bits of each of a plurality of time intervals deriving from the input encoded data by division in a decoding time direction, the input encoded data including variable bit rate encoded data encoded at a variable bit rate beforehand;
a calculator to subtract the input bit rate from a first transmission bit rate to obtain a second transmission bit rate every time interval; and
an encoder to encode video data according to the second transmission bit rate to output encoded data.

2. The video encoding apparatus according to claim 1 wherein the encoded data includes data encoded by lossless encoding.

3. The video encoding apparatus according to claim 1, wherein the encoded data includes data of a sub picture.

4. The video encoding apparatus according to claim 1, further comprising: a simulator to carry out simulation of input and output of a virtual decoder buffer based on the second transmission bit rate and the number of encoded bits which is assigned to each image when the variable bit rate control is carried out by a third transmission bit rate; and a distributor to distribute the number of encoded bits subject to underflow to another image when a buffer of a virtual decoder underflows.

5. The video encoding apparatus according to claim 1, wherein the first transmission bit rate is a transmission bit rate at which the input encoded data encoded at the variable bit rate and the video data encoded with the encoder are multiplexed.

6. The video encoding apparatus according to claim 1, wherein each of the plurality of time intervals is not less than a value obtained by dividing a size of a buffer of a system target decoder necessary for separating data multiplexed at the first transmission bit rate at the first transmission bit rate.

7. The video encoding apparatus according to claim 1, wherein each of the plurality of time intervals is a value not less than a length of GOP to be encoded.

8. The video encoding apparatus according to claim 6, which further comprises a multiplexer of a MPEG2 PS (Program Stream) scheme which multiplexes the encoded data encoded at the variable bit rate and the video data encoded with the encoder, and wherein the buffer of the system target decoder includes a P-STD buffer.

9. The video encoding apparatus according to claim 6, which further comprises a multiplexer of a MPEG2 TS (Transport Stream) scheme which multiplexes the encoded data encoded at the variable bit rate and the video data encoded with the encoder, and wherein the buffer of the system target decoder includes a T-STD buffer.

10. A video encoding method comprising:
calculating an input bit rate every time interval of input encoded data from the number of encoded bits of each of a plurality of time intervals derived from the input encoded data by division in a decoding time direction, the input encoded data including variable bit rate encoded data encoded at a variable bit rate beforehand;
subtracting the input bit rate from a first transmission bit rate to calculate a second transmission bit rate for every time interval;
carrying out simulation of input and output of a virtual decoder buffer based on the second transmission bit rate and the number of encoded bits which is assigned to each image when the variable bit rate control is carried out at a third transmission bit rate; and
distributing the number of encoded bits subject to underflow to another image when a buffer of a virtual decoder underflows.

11. A video encoding method comprising:
multiplexing the encoded data at a first transmission bit rate in order to minimize a delay time from a time when encoded data including encoded data encoded at a variable bit rate beforehand is input to a time when the encoded data is decoded;
calculating a second transmission bit rate corresponding to the number of encoded bits per a time interval in which the video data is multiplexed with the multiplexed data;
carrying out simulation of input and output of a virtual decoder buffer based on the second transmission bit rate and the number of encoded bits which is assigned to each image supposing that variable bit rate control is carried out by a third transmission bit rate; and
distributing the number of encoded bits subject to underflow to another image when the virtual decoder buffer underflows.

12. A computer readable storage medium storing instructions of a computer program which when executed by a computer results in performance of steps comprising:
calculating an input bit rate for every time interval of input encoded data from the number of encoded bits of each of a plurality of time intervals derived from the input encoded data by division in a decoding time direction, the input encoded data including variable bit rate encoded data encoded at a variable bit rate beforehand;
calculating a second transmission bit rate every time interval by subtracting the input bit rate from the first transmission bit rate;
carrying out simulation of input and output of a virtual decoder buffer based on the second transmission bit rate and the number of encoded bits which is assigned to each image when the variable bit rate control is carried out at a third transmission bit rate; and
distributing the number of encoded bits subject to underflow to another image when a buffer of a virtual decoder underflows.

13. A computer readable storage medium storing instructions of a computer program which when executed by a computer results in performance of steps comprising:
multiplexing the encoded data at a first transmission bit rate in order to minimize a delay time from a time when encoded data including encoded data encoded at a variable bit rate beforehand is input to a time when the encoded data is decoded;
calculating a second transmission bit rate corresponding to the number of encoded bits per a time interval in which the video data is multiplexed with the multiplexed data;
carrying out simulation of input and output of a virtual decoder buffer based on the number of encoded bits which is assigned to each image supposing that variable bit rate control is carried out at a third transmission bit rate and the second transmission bit rate,
distributing the number of encoded bits subject to underflow to another image when the virtual decoder buffer underflows.
